(19) United States
(12) Patent Application Publication
(10) Pub. No.: US 2026/0206742 A1
(43) Pub. Date: Jul. 23, 2026

(54) HERBICIDAL COMPOSITION WITH BUILT-IN ADJUVANT

(71) Applicant: BASF SE, Ludwigshafen (DE)

(72) Inventors: Bernd Sievernich, Limburgerhof (DE); Claude Taranta, Limburgerhof (DE); Benjamin Gicquel, Ecully (FR); Katja Marxer, Limburgerhof (DE); Katharine Klamczynski, Limburgerhof (DE)

(21) Appl. No.: 19/139,408

(22) PCT Filed: Dec. 18, 2023
(86) PCT No.: PCT/EP2023/086323

§ 371 Date: Jun. 16, 2025

(30) Foreign Application Priority Data
Dec. 21, 2022 (EP) 22215419.7

(51) Int. Cl. A01N 25/02; A01N 43/10; A01N 43/40; A01P 13/00

(52) U.S. Cl. CPC A01N 25/02; A01N 43/10; A01N 43/40; A01P 13/00

(57) ABSTRACT

The present invention relates to a herbicidal composition comprising dimethenamid or dimethenamid-P (herbicide A), a salt of aminopyralid (herbicide B) and a specific built-in adjuvant C, to the use or method for controlling undesirable vegetation by applying said composition and to a method for improving the herbicidal activity of compositions comprising the herbicides A and B, in particular in crops.

The present invention relates to a herbicidal composition comprising dimethenamid or dimethenamid-P (herbicide A), a salt of aminopyralid (herbicide B) and a specific built-in adjuvant C, to the use or method for controlling undesirable vegetation by applying said composition and to a method for improving the herbicidal activity of compositions comprising the herbicides A and B, in particular in crops.

### BACKGROUND OF THE INVENTION

In crop protection, it is desirable, in principle, to increase the specific activity of an active compound and the reliability of the effect. It is particularly desirable for the crop protection product to control the harmful plants effectively, but at the same time to be compatible with the useful plants in question. Also desirable is a broad spectrum of activity allowing the simultaneous control of harmful plants. Frequently, this cannot be achieved using a single herbicidally active compound.

An agricultural formulation containing the chloroacetamide herbicide dimethenamid or dimethenamid-P and a salt of the pyridinecarboxylic acid herbicide aminopyralid would be very useful for weed control, especially in crops from the genus Brassica (e.g., oilseed rape or canola), for example with a view to providing flexibility of its application from pre-emergence to post-emergence.

Dimethenamid (i.e. (RS)-2-chloro-N-(2,4-dimethyl-3-thienyl)-N-(2-methoxy-1-methylethyl)acetamide) and its S-isomer with the common name dimethenamid-P (i.e. (S)-2-chloro-N-(2,4-dimethyl-3-thienyl)-N-(2-methoxy-1-methylethyl)acetamide) are known herbicides that are described in the The Pesticide Manual, Fourteenth Edition, Editor: C. D. S. Tomlin, British Crop Production Council, 2006, entry 268, pages 341-343. Dimethenamid and dimethenamid-P are both used for pre- or early post-emergence control of annual grass and broad-leaved weeds in various crops.

Aminopyralid (i.e., 4-amino-3,6-dichloro-2-pyridinecarboxylic acid), as well as methods of making and using thereof, are known in the art, see, for example, U.S. Pat. No. 6,297,197. The herbicidal activity of aminopyralid is described, for example, in The Pesticide Manual, Fourteenth Edition, Editor: C. D. S. Tomlin, British Crop Production Council, 2006, entry 23, pages 30-31). Aminopyralid or salts thereof are commercially available, for example from Corteva Agriscience under the trademark MILESTONE™.

Adjuvants are important components of agrochemical formulations and are defined as substances which can increase the biological activity of the active ingredient but are themselves not significantly biologically active. Adjuvants assist with the effectiveness of the active ingredient such as, for example, by improving the delivery and uptake of an herbicide into a target weed plant leading to improved biological control. Adjuvants can be added directly to a formulated agricultural product to provide improved performance of the product upon application. Various adjuvants are known in the art such as, for example, surfactants, spreaders, petroleum and plant derived oils and solvents, and wetting agents. Examples of commonly used adjuvants include, but are not limited to, paraffin oil, horticultural spray oils (e.g., summer oil), methylated rape seed oil, methylated soybean oil, highly refined vegetable oil and the like, polyol fatty acid esters, polyethoxylated esters, ethoxylated alcohols, alkyl polysaccharides and blends, amine ethoxylates, sorbitan fatty acid ester ethoxylates, polyethylene glycol esters, organosilicone based surfactants, ethylene vinyl acetate terpolymers, ethoxylated alkyl aryl phosphate esters and the like.

WO 2009/153247 A2 (equivalent to US 2011/092367 A1) discloses herbicidal compositions comprising aminopyralid and a herbicide from the group of lipid biosynthesis inhibitors, inter alia chloroacetanilides such as dimethenamid or dimethenamid-P.

CN 108402042 A discloses a herbicidal composition comprising dimethenamid and thifensulfuron-methyl. The composition may contain an auxiliary agent which can be an emulsifier such as, for example, sorbitan fatty acid ester polyoxyethylene ethers from the Tween series.

US 2021/184441 A1 discloses, inter alia, an emulsion comprising the potassium salt of aminopyralid, fluroxypyr methylheptylester (MHE) and Tween 61, i.e., a polyoxyalkylene sorbitan fatty acid ester.

Watson M. C. et al, “Action of Selected Herbicides and Tween 20 on Oat (Avena sativa) Membranes”, Weed Science, Volume 28, Issue 1, January 1980, pp. 122-127 discloses studies of the leakage of intracellular ¹⁴C-material from oat protoplasts treated with selected herbicides, Tween 20, or various herbicide-Tween 20 combinations and of the effect of these herbicides on ATPase activity associated with oat root plasma membranes.

Penfield, K. et al., “Physical and Biological Effects of Modified Polysorbate 20,” Pesticide Formulation and Delivery Systems: 34th Volume, Translating Basic Science into Products, STP 1579, Yasmith Bernal, Ed., pp. 76-93, doi: 10.1520/STP157920130188, ASTM International, West Conshohocken, PA 2015 discloses investigations about the physical and biological properties including the herbicidal activity of polysorbate 20 and variants thereof.

There are a number of options to control weeds in crops, in particular of the genus Brassica such as oilseed rape or canola. Certain products also have flexible timing and can be applied from pre-emergence to post-emergence. Pre-emergence treatment generally minimizes weed competitiveness during the most critical phase of germination and early crop establishment, and post-emergence treatment generally allows a more adapted use to the prevalent weed infestation in the field. Moreover, there is widespread trend towards the reduction of the dosage of herbicidal active ingredients as far as possible so as to minimize the environmental impact in crop protection.

Aminopyralid is an active substance which, applied either in pre- or post-emergence, provides good efficacy on important broadleaf weeds. However, the maximum application rates of aminopyralid differ between a pre-emergence and a post-emergence treatment. While for a solo aminopyralid product, different dose rates can be managed more easily, the adjustment of dose rates for a ready mixture with other herbicides also has an impact on the co-formulated active ingredient.

There is a still a need to find ready-mix formulations including different active substances while achieving a better activity than the respective tank mixtures, providing farmers with greater flexibility in application timing from pre- to post-emergence treatments and still complying with the maximum dose rates of the individual active substances and ensuring crop safety, especially in Brassica crops such as oilseed rape or canola.

### SUMMARY OF THE INVENTION

It was therefore an object of the present invention to provide a herbicidal composition comprising dimethenamid or dimethenamid-P as herbicide A and a salt of aminopyralid as herbicide B which is suitable as a ready-mix formulation, achieves a better activity than the respective tank mixture and/or formulation of herbicides A and B and allows more flexibility in application timing from pre- to post-emergence treatments, whilst complying with the maximum dose rates of said herbicides A and B and ensuring excellent crop safety, particularly in crops from the genus Brassica (e.g., oilseed rape or canola).

These and further objects are achieved by the herbicidal composition as described below.

Accordingly, in one aspect of the invention, there is provided a herbicidal composition comprising
a) a herbicide A selected from dimethenamid, dimethenamid-P and any mixture thereof,
b) a herbicide B which is an agriculturally acceptable salt of aminopyralid, and
c) a built-in adjuvant C selected from polyoxyalkylene sorbitan fatty acid esters.

Surprisingly, it was found that the herbicidal activity of a composition comprising dimethenamid or dimethenamid-P as herbicide A and a salt of aminopyralid as herbicide B can be significantly improved in both pre-emergence and post-emergence application by incorporating a specific built-in adjuvant C selected from polyoxyalkylene sorbitan fatty acid esters into said composition while at the same time not increasing phytotoxicity against the crop plants, particularly crops from the genus Brassica (e.g., oilseed rape or canola). Moreover, the herbicidal composition of this invention ensures a more flexible application timing from pre- to post-emergence treatments and still complies with the maximum dose rates of said herbicides A and B.

The present invention further relates to the use of the herbicidal composition as defined herein for controlling undesirable vegetation in a crop and to a method for controlling undesirable vegetation in a crop comprising applying the herbicidal composition as defined herein to the vegetation or the locus thereof.

The present invention also provides a method for improving the herbicidal activity of a herbicidal composition comprising
a) a herbicide A selected from dimethenamid, dimethenamid-P and any mixture thereof, and
b) a herbicide B which is an agriculturally acceptable salt of aminopyralid, against undesirable vegetation in a crop comprising incorporating into said composition
c) a built-in adjuvant C selected from polyoxyalkylene sorbitan fatty acid esters.

All amounts, concentrations, ratios and percentages are by weight unless otherwise indicated. In this regard, “wt. %” and “% by weight” as used herein all relate to weight percentage.

The following definitions apply to terms as used herein.

The articles “a”, “an” and “the” each refer to one or more, unless otherwise indicated.

The term “agriculturally acceptable salt(s)” is used herein to mean in general, the salts of those cations and the acid addition salts of those acids whose cations and anions, respectively, have no adverse effect on the herbicidal activity of the active compounds, in particular aminopyralid.

The terms “plants” and “vegetation”, as used herein, include germinant seeds, emerging seedlings, plants emerging from vegetative propagules, and established vegetation.

The terms “controlling” and “combating”, as used herein, are synonyms.

The terms “undesirable vegetation”, “harmful plants”, “unwanted plants”, “weeds” and “weed species”, as used herein, are synonyms.

The term “locus”, as used herein, means the area in which the vegetation or plants are growing or will grow, typically a field.

Further embodiments of the invention are evident from the description, the examples and the claims. It is to be understood that the features mentioned above and still to be illustrated below of the subject matter of the invention can be applied not only in the combination given in each particular case but also in other combinations, without leaving the scope of the invention.

### DETAILED DESCRIPTION OF THE INVENTION

The herbicidal composition of this invention comprises, as component a), the herbicide A selected from dimethenamid, dimethenamid-P and any mixture thereof. Preferably, the herbicide A is dimethenamid-P.

The herbicidal composition of this invention comprises, as component b), the herbicide B which is an agriculturally acceptable salt of aminopyralid.

Exemplary agriculturally acceptable salts of aminopyralid include, for example, sodium salts, potassium salts, ammonium salts or substituted ammonium salts, in particular mono-, di-, and tri-C₁-C₈-alkylammonium salts such as methyl ammonium, dimethylammonium, triethylammonium, and isopropylammonium, mono-, di- and tri-hydroxy-C₂-C₈-alkylammonium salts such as hydroxyethylammonium, di(hydroxyethyl)ammonium, tri(hydroxyethyl)ammonium, hydroxypropylammonium, di(hydroxypropyl)ammonium and tri(hydroxypropyl)ammonium salts, triisopropanolammonium salts, olamine salts, and diglycolamine salts.

In a preferred embodiment, the agriculturally acceptable salt of aminopyralid is selected from aminopyralid-sodium, aminopyralid-potassium, aminopyralid-choline salt, aminopyralid-ammonium, aminopyralid-methylammonium, aminopyralid-dimethylammonium, aminopyralid-isopropylammonium, aminopyralid-hydroxy ethylammonium, aminopyralid-di(hydroxyethyl)ammonium, aminopyralid-tri(hydroxyethyl)ammonium, aminopyralid-hydroxypropylammonium, aminopyralid-di(hydroxypropyl)ammonium, aminopyralid-tri(hydroxypropyl)ammonium, aminopyralid-triisopropanolammonium, aminopyralid-diglycolamine salt, aminopyralid-olamine salt, aminopyralid-dimethylamine salt, aminopyralid-monoethanolamine salt, aminopyralid-triisopropanolamine salt, and any combination thereof and more preferably from aminopyralid-potassium, aminopyralid-dimethylammonium, aminopyralid-triisopropanolamine salt, and any combination thereof. In particular, the herbicide B is aminopyralid-potassium.

The herbicidal composition of this invention comprises, as component c), the built-in adjuvant C selected from polyoxyalkylene sorbitan fatty acid esters.

The term “built-in adjuvant” refers to one or more adjuvants that have been added to the herbicidal composition (in particular an agrochemical formulation, such as a liquid agrochemical formulation), at the manufacturing stage of the product, rather than at the point of use of the product such as, for example, to a spray solution. The use of built-in adjuvants simplifies the use of agrochemical products for the end-user by reducing the number of ingredients that must be individually measured and applied.

In the polyoxyalkylene sorbitan fatty acid esters used in this invention, the number of addition of the oxyalkylene moiety is preferably from 1 to 100, more preferably from 1 to 50, yet more preferably from 1 to 30 and in particular from 4 to 30. Further, the oxyalkylene moiety may be either linear or branched, and it preferably has, for example, from 2 to 3 carbon atoms. Specific examples thereof include ethylene oxide, propylene oxide and —CH(CH₃)CH₂O—. The oxyalkylene moiety may be a copolymer or a block copolymer, and the position of substitution of the oxyalkylene moiety is not particularly limited. The polyoxyalkylene sorbitan fatty acid ester may be any of a mono-fatty acid ester, a di-fatty acid ester and a tri-fatty acid ester. The fatty acid moiety of the polyoxyalkylene sorbitan fatty acid ester may be either a saturated fatty acid or an unsaturated fatty acid. The fatty acid moiety has preferably from 4 to 24, more preferably from 8 to 20 carbon atoms. The fatty acid moiety may be linear, branched or cyclic, and may have a substituent. The number of the unsaturated bond(s) in the unsaturated fatty acid may be one or more, and the position is also optional. Specific examples of the fatty acid moiety include butyric acid, valeric acid, caproic acid, enanthic acid, caprylic acid, pelargonic acid, capric acid, lauric acid, myristic acid, pentadecylic acid, palmitic acid, palmitoleic acid, margaric acid, stearic acid, oleic acid, vaccenic acid, linoleic acid, (9, 12, 15)-linolenic acid, tuberculostearic acid, arachidic acid, arachidonic acid, behenic acid, erucic acid, lignoceric acid and nervonic acid.

Specific examples of the polyoxyalkylene sorbitan fatty acid ester, more specifically the polyoxyethylene sorbitan fatty acid ester, include, for example, polyoxyethylene sorbitan monolaurate, polyoxyethylene sorbitan dilaurate, polyoxyethylene sorbitan trilaurate, polyoxyethylene sorbitan monopalmitate, polyoxyethylene sorbitan dipalmitate, polyoxyethylene sorbitan tripalmitate, polyoxyethylene sorbitan monomyristate, polyoxyethylene sorbitan dimyristate, polyoxyethylene sorbitan trimyristate, polyoxyethylene sorbitan monostearate, polyoxyethylene sorbitan distearate, polyoxyethylene sorbitan tristearate, polyoxyethylene sorbitan monoisostearate, polyoxyethylene sorbitan diisostearate, polyoxyethylene sorbitan triisostearate, polyoxyethylene sorbitan monooleate, polyoxyethylene sorbitan dioleate, and polyoxyethylene sorbitan trioleate. The above adjuvants are all commercially available substances from different suppliers.

In a preferred embodiment, the built-in adjuvant C is selected from polyoxyethylene sorbitan fatty acid esters. In a particularly preferred embodiment, the built-in adjuvant C is polyoxyethylene sorbitan monolaurate, more specifically polyoxyethylene (20) sorbitan monolaurate. Commercial brand names of said adjuvant include Montanox® 20, Alkest® TW 20 and Tween® 20.

The herbicidal composition of this invention may optionally comprise, as component d), a herbicide D which is different from the herbicides A and B. This further herbicide D is usually selected from the following groups d1) to d18):
d1) from the group of the lipid biosynthesis inhibitors: clodinafop-propargyl, cycloxydim, cyhalofop-butyl, fenoxaprop-P-ethyl, pinoxaden, profoxydim, tepraloxydim, tralkoxydim, 4-(4′-Chloro-4-cyclopropyl-2′-fluoro[1,1′-biphenyl]-3-yl)-5-hydroxy-2,2,6,6-tetramethyl-2H-pyran-3 (6H)-one (CAS 1312337-72-6); 4-(2′,4′-Dichloro-4-cyclopropyl[1,1′-biphenyl]-3-yl)-5-hydroxy-2,2,6,6-tetramethyl-2H-pyran-3 (6H)-one (CAS 1312337-45-3); 4-(4′-Chloro-4-ethyl-2′-fluoro[1,1′-biphenyl]-3-yl)-5-hydroxy-2,2,6,6-tetramethyl-2H-pyran-3 (6H)-one (CAS 1033757-93-5); 4-(2′,4′-Dichloro-4-ethyl[1,1′-biphenyl]-3-yl)-2,2,6,6-tetramethyl-2H-pyran-3,5(4H, 6H)-dione (CAS 1312340-84-3); 5-(Acetyloxy)-4-(4′-chloro-4-cyclopropyl-2′-fluoro[1,1′-biphenyl]-3-yl)-3,6-dihydro-2,2,6,6-tetramethyl-2H-pyran-3-one (CAS 1312337-48-6); 5-(Acetyloxy)-4-(2′,4′-dichloro-4-cyclopropyl-[1,1′-biphenyl]-3-yl)-3,6-dihydro-2,2,6,6-tetramethyl-2H-pyran-3-one; 5-(Acetyloxy)-4-(4′-chloro-4-ethyl-2′-fluoro[1,1′-biphenyl]-3-yl)-3,6-dihydro-2,2,6,6-tetramethyl-2H-pyran-3-one (CAS 1312340-82-1); 5-(Acetyloxy)-4-(2′,4′-dichloro-4-ethyl[1,1′-biphenyl]-3-yl)-3,6-dihydro-2,2,6,6-tetramethyl-2H-pyran-3-one (CAS 1033760-55-2); 4-(4′-Chloro-4-cyclopropyl-2′-fluoro[1,1′-biphenyl]-3-yl)-5,6-dihydro-2,2,6,6-tetramethyl-5-oxo-2H-pyran-3-yl carbonic acid methyl ester (CAS 1312337-51-1); 4-(2′,4′-Dichloro-4-cyclopropyl-[1,1′-biphenyl]-3-yl)-5,6-dihydro-2,2,6,6-tetramethyl-5-oxo-2H-pyran-3-yl carbonic acid methyl ester; 4-(4′-Chloro-4-ethyl-2′-fluoro[1,1′-biphenyl]-3-yl)-5,6-dihydro-2,2,6,6-tetramethyl-5-oxo-2H-pyran-3-yl carbonic acid methyl ester (CAS 1312340-83-2); 4-(2′,4′-Dichloro-4-ethyl[1,1′-biphenyl]-3-yl)-5,6-dihydro-2,2,6,6-tetramethyl-5-oxo-2H-pyran-3-yl carbonic acid methyl ester (CAS 1033760-58-5);
d2) from the group of the ALS inhibitors: bensulfuron-methyl, bispyribac-sodium, cyclosulfamuron, diclosulam, ethametsulfuron, flumetsulam, flupyrsulfuron-methyl-sodium, foramsulfuron, imazamox, imazapic, imazapyr, imazaquin, imazethapyr, imazosulfuron, iodosulfuron, iodosulfuron-methyl-sodium, iofensulfuron, iofensulfuron-sodium, mesosulfuron, metazosulfuron, nicosulfuron, penoxsulam, propoxycarbazon-sodium, propyrisulfuron, pyrazosulfuron-ethyl, pyroxsulam, rimsulfuron, sulfosulfuron, thiencarbazon-methyl, tritosulfuron and triafamone;
d3) from the group of the photosynthesis inhibitors: ametryn, atrazine, diuron, fluometuron, hexazinone, isoproturon, linuron, metribuzin, paraquat, paraquat-dichloride, propanil, terbutryn, terbuthylazine, 1-(5-tert-butylisoxazol-3-yl)-2-hydroxy-4-methoxy-3-methyl-2H-pyrrol-5-one (CAS 1637455-12-9), 1-(5-tert-butylisoxazol-3-yl)-4-chloro-2-hydroxy-3-methyl-2H-pyrrol-5-one (CAS 1637453-94-1), 1-(5-tert-butylisoxazol-3-yl)-4-ethoxy-5-hydroxy-3-methyl-imidazolidin-2-one (CAS 1844836-64-1);
d4) from the group of the protoporphyrinogen-IX oxidase inhibitors: cyclopyranil, flumioxazin, oxyfluorfen, pyraflufen, pyraflufen-ethyl, saflufenacil, sulfentrazone, trifludimoxazin, epyrifenacil, 3-[7-fluoro-3-oxo-4-(prop-2-ynyl)-3,4-dihydro-2H-benzo[1,4]oxazin-6-yl]-1,5-dimethyl-6-thioxo-[1,3,5]triazinan-2,4-dione (CAS 451484-50-7), 2-(2,2,7-trifluoro-3-oxo-4-prop-2-ynyl-3,4-dihydro-2H-benzo[1,4]oxazin-6-yl)-4,5,6,7-tetrahydro-isoindole-1,3-dione (CAS 1300118-96-0), and 1-methyl-6-trifluoromethyl-3-(2,2,7-trifluoro-3-oxo-4-prop-2-ynyl-3,4-dihydro-2H-benzo[1,4]oxazin-6-yl)-1H-pyrimidine-2,4-dione (CAS 1304113-05-0);
2-[2-chloro-5-[3-chloro-5-(trifluoromethyl)-2-pyridinyl]-4-fluorophenoxy]-2-methoxy-acetic acid methyl ester (CAS 1970221-16-9), 2-[2-[[3-chloro-6-[3,6-dihydro-3-methyl-2,6-dioxo-4-(trifluoromethyl)-1(2H)-pyrimidinyl]-5-fluoro-2-pyridinyl]oxy]phenoxy]-acetic acid methyl ester (CAS 2158274-96-3), 2-[2-[[3-chloro-6-[3,6-dihydro-3-methyl-2,6-dioxo-4-(trifluoromethyl)-1(2H)-pyrimidinyl]-5-fluoro-2-pyridinyl]oxy]phenoxy]acetic acid ethyl ester (CAS 158274-50-9), methyl 2-[[3-[2-chloro-5-[4-(difluoromethyl)-3-methyl-5-oxo-1,2,4-triazol-1-yl]-4-fluoro-phenoxy]-2-pyridyl]oxy-]acetate (CAS 2271389-22-9), ethyl 2-[[3-[2-chloro-5-[4-(difluoromethyl)-3-methyl-5-oxo-1,2,4-triazol-1-yl]-4-fluoro-phenoxy]-2-pyridyl]oxy]acetate (CAS 2230679-62-4), 2-[[3-[[3-chloro-6-[3,6-dihydro-3-methyl-2,6-dioxo-4-(trifluoromethyl)-1(2H)-pyrimidinyl]-5-fluoro-2-pyridinyl]oxy]-2-pyridinyl]oxy]-acetic acid methyl ester (CAS 2158275-73-9), 2-[[3-[[3-chloro-6-[3,6-dihydro-3-methyl-2,6-dioxo-4-(trifluoromethyl)-1(2H)-pyrimidinyl]-5-fluoro-2-pyridinyl]oxy]-2-pyridinyl]oxy]acetic acid ethyl ester (CAS 2158274-56-5), 2-[2-[[3-chloro-6-[3,6-dihydro-3-methyl-2,6-dioxo-4-(trifluoromethyl)-1(2H)-pyrimidinyl]-5-fluoro-2-pyridinyl]oxy]phenoxy]-N-(methylsulfonyl)-acetamide (CAS 2158274-53-2), 2-[[3-[[3-chloro-6-[3,6-dihydro-3-methyl-2,6-dioxo-4-(trifluoromethyl)-1(2H)-pyrimidinyl]-5-fluoro-2-pyridinyl]oxy]-2-pyridinyl]oxy]-N-(methylsulfonyl)acetamide (CAS 2158276-22-1), 3-[2-chloro-5-[3,6-dihydro-3-methyl-2,6-dioxo-4-(trifluoromethyl)-1(2H)-pyrimidinyl]-4-fluorophenyl]-4,5-dihydro-5-methyl-5-isoxazolecarboxylic acid ethyl ester (CAS 1949837-17-5);
   b5) from the group of the bleacher herbicides: amitrole, bicyclopyrone, broclozone, clomazone, diflufenican, fenquinotrione, flumeturon, flurochloridone, isoxaflutole, mesotrione, oxotrione (CAS 1486617-21-3), picolinafen, sulcotrione, tefuryltrione, tembotrione, tolpyralate, topramezone, 2-chloro-3-methylsulfanyl-N-(1-methyltetrazol-5-yl)-4-(trifluoromethyl)benzamide (CAS 1361139-71-0), bixlozone, 2-(2,5-dichlorophenyl)methyl-4,4-dimethyl-3-isoxazolidinone (CAS 81778-66-7), and chloro-2-[-3-(difluoromethyl) isoxazol-5-yl]phenyl-5-chloropyrimidin-2-yl-ether;
   d6) from the group of the EPSP synthase inhibitors: glyphosate, glyphosate-isopropylammonium and glyphosate-trimesium (sulfosate);
   d7) from the group of the glutamine synthase inhibitors: glufosinate, glufosinate-P and glufosinate-ammonium;
   d8) from the group of the DHP synthase inhibitors: asulam;
   d9) from the group of the mitosis inhibitors: pendimethalin, propyzamid and trifluralin;
   d10) from the group of the VLCFA inhibitors: chloroacetamides such as acetochlor, alachlor, allidochlor, amidochlor, butachlor, butenachlor, delachlor, diethatyl, dimethachlor, ethachlor, ethaprochlor, metazachlor, metolachlor, S-metolachlor, pethoxamid, pretilachlor, propachlor, propisochlor, prynachlor, terbuchlor, thenylchlor and xylachlor, oxyacetamides such as flufenacet and mefenacet, carboxamides such as cafenstrole, fentrazamide and ipfencarbazone, thiocarbamates such as dimepiperate, esprocarb, prosulfocarb, thiobencarb and tri-allate, and other herbicides such as anilofos, ethofumesate, fenoxasulfone, indanofan, piperophos, pyroxasulfone and dimesulfazet;
   d11) from the group of the cellulose biosynthesis inhibitors: indaziflam, isoxaben and triaziflam;
   b12) from the group of the decoupler herbicides: dinoseb, dinoterb and DNOC and its salts;
   d13) from the group of the auxinic herbicides: 2,4-D and its salts and esters such as clacyfos, and aminocyclopyrachlor and its salts and esters, clopyralid and its salts and esters, dicamba and its salts and esters, fluroxypyr, fluroxypyr-meptyl, halauxifen, halauxifen-methyl, picloram and its salts and esters, quinclorac, quinmerac, florpyrauxifen, florpyrauxifen-benzyl (CAS 1390661-72-9) and 4-amino-3-chloro-5-fluoro-6-(7-fluoro-1H-indol-6-yl) picolinic acid (CAS 1629965-65-6);
   d14) from the group of the auxin transport inhibitors: diflufenzopyr and diflufenzopyr-sodium;
   d15) from the group of the other herbicides: acetamides such as diphenamid, naproanilide, napropamide and napropamide-M, dymron (=daimuron), oxaziclomefone, 6-chloro-4-(2,7-dimethyl-1-naphthyl)-5-hydroxy-2-methyl-pyridazin-3-one (CAS 2414510-21-5);
   d16) from the group of inhibitors of fatty acid thioesterase: cinmethylin, methiozolin;
   d17) from the group of dihydroorotate dehydrogenase inhibitor: tetflupyrolimet; and
   d18) from the group of solanesyl diphosphate synthase Inhibitor: aclonifen.

In a preferred embodiment, the herbicide D is selected from bixlozone, broclozone, cinmethylin, clomazone, imazamox, ethametsulfuron, acetochlor, dimethachlor, metazachlor, metolachlor, S-metolachlor, pethoxamid, napropamide, napropamide-M, clopyralid and its salts and esters, halauxifen, halauxifen-methyl, picloram and its salts and esters, quinmerac, florpyrauxifen and florpyrauxifen-benzyl.

The herbicidal composition of this invention may optionally comprise, as component e), a safener E.

Safeners are chemical compounds which prevent or reduce damage on useful plants without having a major impact on the herbicidal action of the herbicidal active components of the present compositions towards unwanted plants. They can be applied either before sowings (e.g. on seed treatments, shoots or seedlings) or in the pre-emergence application or post-emergence treatment of useful plants and their habitat.

Suitable safeners are e.g. (quinolin-8-oxy)acetic acids, 1-phenyl-5-haloalkyl-1H-1,2,4-triazol-3-carboxylic acids, 1-phenyl-4,5-dihydro-5-alkyl-1H-pyrazol-3,5-dicarboxylic acids, 4,5-dihydro-5,5-diaryl-3-isoxazol carboxylic acids, dichloroacetamides, alpha-oximinophenylacetonitriles, acetophenonoximes, 4,6-dihalo-2-phenylpyrimidines, N-[[4-(aminocarbonyl)phenyl]sulfonyl]-2-benzoic amides, 1,8-naphthalic anhydride, 2-halo-4-(haloalkyl)-5-thiazol carboxylic acids, phosphorthiolates and N-alkyl-O-phenylcarbamates and their agriculturally acceptable salts and their agriculturally acceptable derivatives such amides, esters, and thioesters, provided they have an acid group.

Examples of preferred safeners E are benoxacor, cloquintocet, cyometrinil, cyprosulfamide, dichlormid, dicyclonon, dietholate, fenchlorazole, fenclorim, flurazole, fluxofenim, furilazole, isoxadifen, mefenpyr, mephenate, naphthalic anhydride, oxabetrinil, 4-(dichloroacetyl)-1-oxa-4-azaspiro[4.5]decane (MON4660, CAS 71526-31-3), 2,2,5-trimethyl-3-(dichloroacetyl)-1,3-oxazolidine (R-29148, CAS 52836-31-4), metcamifen and BPCMS (CAS 54091-06-4).

Especially preferred safeners E are benoxacor, cloquintocet, cyprosulfamide, dichlormid, fenchlorazole, fenclorim, flurazole, fluxofenim, furilazole, isoxadifen, mefenpyr, naphthalic anhydride, oxabetrinil, 4-(dichloroacetyl)-1-oxa-4-azaspiro[4.5]decane (MON4660, CAS 71526-07-3), 2,2,5-trimethyl-3-(dichloroacetyl)-1,3-oxazolidine (R-29148, CAS 52836-31-4) and metcamifen.

Particularly preferred safeners E are benoxacor, cloquintocet, cyprosulfamide, dichlormid, fenchlorazole, fenclorim, furilazole, isoxadifen, mefenpyr, naphthalic anhydride, 4-(dichloroacetyl)-1-oxa-4-azaspiro[4.5]decane (MON4660, CAS 71526-07-3), 2,2,5-trimethyl-3-(dichloroacetyl)-1,3-oxazolidine (R-29148, CAS 52836-31-4) and metcamifen.

In the compositions of the present invention, the weight ratio of herbicide A (in particular dimethenamid-P) to herbicide B (in particular aminopyralid-potassium), calculated on an acid equivalent basis, is in general in the range from 200:1 to 1:1, preferably in the range from 150:1 to 25:1, most preferably from 100:1 to 40:1. Accordingly, in the methods and uses of the invention, herbicide A (in particular dimethenamid-P) and herbicide B (in particular aminopyralid-potassium) are preferably applied within the aforementioned weight ratios.

In the compositions of the present invention, the weight ratio of herbicide A (in particular dimethenamid-P) to built-in adjuvant C (preferably polyoxyethylene sorbitan monolaurate, in particular polyoxyethylene (20) sorbitan monolaurate) is in general in the range from 80:1 to 1:3, preferably in the range from 50:1 to 1:2, most preferably from 25:1 to 1:1. Accordingly, in the methods and uses of the invention, herbicide A (in particular dimethenamid-P) and built-in adjuvant C (preferably polyoxyethylene sorbitan monolaurate, in particular polyoxyethylene (20) sorbitan monolaurate) are preferably applied within the aforementioned weight ratios.

In the compositions of the present invention, the weight ratio of herbicide B (in particular aminopyralid-potassium), calculated on an acid equivalent basis, to built-in adjuvant C (preferably polyoxyethylene sorbitan monolaurate, in particular polyoxyethylene (20) sorbitan monolaurate) is in general in the range from 1:1 to 1:250, preferably in the range from 1:2 to 1:175, most preferably from 1:3 to 1:100. Accordingly, in the methods and uses of the invention, herbicide B (in particular aminopyralid-potassium) and built-in adjuvant C (preferably polyoxyethylene sorbitan monolaurate, in particular polyoxyethylene (20) sorbitan monolaurate) are preferably applied within the aforementioned weight ratios.

In the compositions of the present invention, the weight ratio of the total amount of herbicide A (in particular dimethenamid-P) and herbicide B (in particular aminopyralid-potassium), calculated on an acid equivalent basis, to built-in adjuvant C (preferably polyoxyethylene sorbitan monolaurate, in particular polyoxyethylene (20) sorbitan monolaurate) is in general in the range from 80:1 to 1:3, preferably in the range from 50:1 to 1:2, most preferably from 25:1 to 1:1. Accordingly, in the methods and uses of the invention, herbicide A (in particular dimethenamid-P), herbicide B (in particular aminopyralid-potassium) and built-in adjuvant C (preferably polyoxyethylene sorbitan monolaurate, in particular polyoxyethylene (20) sorbitan monolaurate) are preferably applied within these weight ratios.

In the compositions of the present invention, the weight ratio of herbicide A (in particular dimethenamid-P) to herbicide B (in particular aminopyralid-potassium), calculated on an acid equivalent basis, to built-in adjuvant C (preferably polyoxyethylene sorbitan monolaurate, in particular polyoxyethylene (20) sorbitan monolaurate) is preferably in the range from 200:1:125 to 40:1:5.

Accordingly, in the methods and uses of the invention, herbicide A (in particular dimethenamid-P), herbicide B (in particular aminopyralid-potassium) and built-in adjuvant C (preferably polyoxyethylene sorbitan monolaurate, in particular polyoxyethylene (20) sorbitan monolaurate) are preferably applied within these weight ratios.

If the compositions of the invention comprise a further herbicide D, the weight ratio of herbicide D to the total amount of herbicide A (in particular dimethenamid-P), herbicide B (in particular aminopyralid-potassium) and built-in adjuvant C (preferably polyoxyethylene sorbitan monolaurate, in particular polyoxyethylene (20) sorbitan monolaurate) is in general from 750:1 to 1:50, preferably from 500:1 to 1:20, more preferably from 400:1 to 1:10 and in particular 300:1 to 1:5, wherein the herbicide B and each herbicide D, which is an ester or a salt of an acid, is calculated on an acid equivalent basis. Accordingly, in the methods and uses of the invention, herbicide A (in particular dimethenamid-P), herbicide B (in particular aminopyralid-potassium), built-in adjuvant C (preferably polyoxyethylene sorbitan monolaurate, in particular polyoxyethylene (20) sorbitan monolaurate) and herbicide D are preferably applied within these weight ratios.

If the compositions of the invention comprise a safener E, the weight ratio of safener E to the total amount of herbicide A (in particular dimethenamid-P), herbicide B (in particular aminopyralid-potassium), built-in adjuvant C (preferably polyoxyethylene sorbitan monolaurate, in particular polyoxyethylene (20) sorbitan monolaurate) and, if present, herbicide D is in general from 500:1 to 1:500, preferably from 400:1 to 1:10, more preferably from 300:1 to 1:1 and in particular 200:1 to 2:1, wherein the herbicide B and each herbicide D and safener E, which is an ester or a salt of an acid, is calculated on an acid equivalent basis. Accordingly, in the methods and uses of the invention, herbicide A (in particular dimethenamid-P), herbicide B (in particular aminopyralid-potassium), built-in adjuvant C (preferably polyoxyethylene sorbitan monolaurate, in particular polyoxyethylene (20) sorbitan monolaurate), herbicide D (if present) and safener E are preferably applied within these weight ratios.

The herbicidal composition, use and method of the present invention are suitable for controlling a large number of undesirable vegetation (harmful plants), including monocotyledonous weeds and dicotyledonous weeds.

In particular, the herbicidal composition, use and method of the present invention may be used for controlling annual weeds such as gramineous weeds (grass weeds) including, but not limited to, the genera Aegilops such as Aegilops cylindrical (AEGCY, jointed goatgrass); Agropyron such as Agropyron repens (AGRRE, common couchgrass); Alopecurus such as Alopecurus myosuroides (ALOMY, blackgrass) or Alopecurus aequalis (ALOAE, foxtail); Apera such as Apera spica-venti (APESV, silky wind grass); Avena such as Avena fatua (AVEFA, wild oat) or Avena sterilis subsp. Sterilis (AVEST, sterile oat); Brachiaria such as Brachiaria plantaginea (BRAPL, Alexander grass) or Brachiaria decumbens (BRADC, Surinam grass); Bromus such as Bromus inermis (BROIN, awnless brome), Bromus sterilis (BROST, barren bromegrass), Bromus tectorum (BROTE, cheatgrass), Bromus arvensis (BROAV, field bromegrass), Bromus secalinus (BROSE, rye bromegrass) or Bromus hordeacus (BROMO, lopgrass); Cenchrus such as Cenchrus echinatus (CCHEC, Mossman River grass); Cynodon such as Cynodon dactylon (CYNDA, bermudagrass); Digitaria such as Digitaria ciliaris (DIGAD, southern crabgrass), Digitaria sanguinalis (DIGSA, hairy crabgrass), Digitaria insularis (TRCIN, sourgrass) or Digitaria ischaemum (DIGIS, smooth crabgrass); Echinochloa such as Echinochloa colonum (ECHCO, awnless barnyardgrass), Echinochloa crus-galli (ECHCG, common barnyard grass), Echinochloa crus-pavonis (ECHCV, Gulf cockspurgrass), Echinochloa oryzoides (ECHOR, early barnyardgrass) or Echinochloa phyllogogon (ECHPH, late barnyardgrass); Eleusine such as Eleusine indica (ELEIN, Indian goosegrass); Eriochloa species such as Eriochloa villosa, Ischaemum such as Ischaemum rugusom (ISCRU, muraina grass); Leptochloa such as Leptochloa chinensis (LEFCH, Chinese sprangletop), Leptochloa fascicularis (LEFFA, salt-meadow grass), Leptochloa filiformis (LEFPC, thread sprangletop), Leptochloa mucronata (LEFFI, red sprangletop), Leptochloa panicoides (LEFPA, tighthead sprangletop), Leptochloa scabra (LEFSC) or Leptochloa virgata (LEFVI, tropical sprangletop); Lolium such as Lolium multiflorum (LOLMU, Italian ryegrass), Lolium perenne (LOLPE, English ryegrass) or Lolium rigidum (LOLRI, annual rye-grass); Panicum such as Panicum capillare (PANCA, tumble panicgrass), Panicum dichotomiflorum (PANDI, smooth witchgrass), Panicum laevifolium (PANLF, sweet panicgrass) or Panicum miliaceum (PANMI, common millet); Phalaris such as Phalaris minor (PHAMI, lesser canary grass), Phalaris paradoxa (PHAPA, paradoxagrass), Phalaris canariensis (PHACA, canarygrass) or Phalaris brachystachys (PHABR, shortspiked canarygrass); Poa such as Poa annua (POAAN, annual bluegrass), Poa pratensis (POAPR, Kentucky bluegrass) or Poa trivialis (POATR, rough meadowgrass); Rottboellia such as Rottboellia exaltata (ROOEX, guinea-fowl grass); Setaria auch as Setaria faberi (SETFA, giant foxtail), Setaria glauca (PESGL, pearl millet), Setaria italic (SETIT, Italian millet), Setaria pumila (SETPU, yellow foxtail), Setaria verticillate (SETVE, bristly foxtail) or Setaria viridis (SETVI, green foxtail); and Sorghum such as Sorghum halepense (SORHA, Johnson grass).

The herbicidal composition, use and method of the present invention are also suitable for controlling a large number of dicotyledonous weeds, in particular broadleaf weeds including, but not limited to, Polygonum species such as Polygonum convolvolus (POLCO, wild buckwheat), Polygonum aviculare (POLAV, common knotgrass) or Polygonum persicaria (POLPE, ladysthumb), Amaranthus species such as Amaranthus albus (AMAAL, tumble pigweed), Amaranthus blitoides (AMABL, mat amaranth), Amaranthus hybridus (AMACH, green pigweed), Amaranthus palmeri (AMAPA, Palmer amaranth), Amaranthus powellii (AMAPO, Powell amaranth), Amaranthus retroflexus (AMARE, redroot pigweed), Amaranthus tuberculatus (AMATU, roughfruit amaranth), Amaranthus rudis (AMATA, tall amaranth) or Amaranthus viridis (AMAVI, slender amaranth), Chenopodium species such as Chenopodium album (CHEAL, common lambsquarters), Chenopodium ficifolium (CHEFI, fig-leaved goosefoot), Chenopodium polyspermum (CHEPO, manyseeded goosefoot) or Chenopodium hybridum (CHEHY, maple-leaf goosefoot), Sida species such as Sida spinosa L. (SIDSP, prickly sida), Ambrosia species such as Ambrosia artemisiifolia (AMBEL, common ragweed), Acanthospermum species, Anthemis species such as Anthemis arvensis (ANTAR, field chamomile), Atriplex species, Cirsium species, Convolvulus species, Conyza species such as Conyza bonariensis (ERIBO, hairy horseweed) or Conyza canadensis (ERICA, Canada horseweed), Cassia species, Commelina species, Datura species, Euphorbia species, Geranium species such as Geranium dissectum (GERDI, cutleaf geranium), Geranium pusillium (GERPU, small-flower geranium) or Geranium rotundifolium (GERRT, roundleaved cranesbill), Galinsoga species such as Galinsoga parviflora (GASPA, gallant soldier), Ipomoea species such as Ipomoea hederacea (IPOHE, morningglory), Lamium species such as Lamium amplexicaule (LAMAM) or Lamium purpureum (LAMPU), Malva species, Matricaria species such as Matricaria chamomilla (MATCH, wild chamomile) or Matricaria discoidea (MATMT, pineapple weed), Tripleurospermum species such as Tripleurospermum inodorum (MATIN, false chamomille), Solanum species such as Solanum nigrum (SOLNI, black nightshade), Xanthium species, Veronica species such as Veronica hederifolia (VERHE) or Veronica persica (VERPE), Viola species such as Viola arvensis (VIOAR), Stellaria species such as Stellaria media (STEME, common chickweed), Abutilon theophrasti (ABUTH, velvet leaf), Hemp sesbania (Sesbania exaltata Cory, SEBEX, Colorado river hemp), Anoda cristata (ANVCR, cottonweed), Bidens pilosa (BIDPI, common blackjack), Centaurea species such as Centaurea cyanus (CENCY, cornflower), Galeopsis tetrahit (GAETE common hemp nettle), Galium aparine (GALAP, cleavers or goosegrass), Galium spurium (GALSP, false cleavers), Galium tricornutum (GALTC, corn cleavers), Helianthus annuus (HELAN, common sunflower), Desmodium tortuosum (DEDTO, giant beggar weed), Kochia scoparia (KCHSC, mock cypress), Mercurialis annua (MERAN, annual mercury), Myosotis arvensis (MYOAR, field forget-me-not), Papaver rhoeas (PAPRH, common poppy), Raphanus raphanistrum, Salsola kali (SASKA, prickly glasswort), Sonchus arvensis (SONAR, corn sowthistle), Tagetes minuta (TAGMI, Mexican marigold), Richardia brasiliensis (RCHBR, Brazil pusley), cruciferous weeds such as Raphanus raphanistrum (RAPRA, wild radish), Sinapis alba (SINAL, white mustard), Sinapis arvensis (SINAR, wild mustard), Thlaspi arvense (THLAR, fanweed), Descurainia sophia (DESSO, flixweed), Capsella bursa-pastoris (CAPBP, shepherd's purse), Sisymbrium species such as Sisymbrium officinale (SSYOF, hedge mustard) or Sisymbrium orientale (SSYOR, oriental mustard), Brassica kaber (SINAR, wild mustard).

The herbicidal composition, use and method of the present invention are also suitable for controlling a large number of annual and perennial sedge weeds including Cyperus species such as purple nutsedge (Cyperus rotundus L.), yellow nutsedge (Cyperus esculentus L.), hime-kugu (Cyperus brevifolius H.), sedge weed (Cyperus microiria Steud), rice flatsedge (Cyperus iria L.), and the like.

In a preferred embodiment, the undesirable vegetation is selected from the genera Aethusa, Anthemis, Apera, Capsella, Centaurea, Chenopodium, Consolida, Daucus, Descurainia, Euphorbia, Galium, Geranium, Lamium, Matricaria, Papaver, Polygonum, Sisymbrium, Stellaria, Thlaspi, Tripleurospermum, Veronica and Viola, more preferably selected from the genera Aethusa, Anthemis, Apera, Capsella, Centaurea, Chenopodium, Daucus, Descurainia, Galium, Geranium, Lamium, Matricaria, Papaver, Polygonum, Sysimbrium, Stellaria, Tripleurospermum, Veronica and Viola, yet more preferably selected from the genera Aethusa, Anthemis, Apera, Capsella, Centaurea, Chenopodium, Daucus, Descurainia, Galium, Geranium, Lamium, Matricaria, Papaver, Stellaria, Tripleurospermum, Veronica and Viola, still more preferably selected from Anthemis, Capsella, Chenopodium, Daucus, Geranium, Lamium, Papaver, Veronica and Viola, and most preferably selected from Anthemis, Geranium, Papaver, Veronica and Viola.

In a particularly preferred embodiment, the undesirable vegetation is selected from the weed species Aethusa cynapium (AETCY), Aethusa sp. (AETSS), Anthemis arvensis (ANTAR), Apera spica-venti (APESV), Capsella bursa-pastoris (CAPBP), Centaurea cyanus (CENCY), Chenopodium album (CHEAL), Consolida regalis (CNSRE), Daucus carota (DAUCA), Descurainia sophia (DESSO), Euphorbia helioscopia (EPHHE), Galium aparine (GALAP), Geranium dissectum (GERDI), Geranium pusillium (GERPU), Geranium rotundifolium (GERRT), Geranium sp. (GERSS), Lamium amplexicaule (LAMAM), Lamium purpureum (LAMPU), Matricaria chamomilla (MATCH), Papaver rhoeas (PAPRH), Polygonum convolvulus (POLCO), Sisymbrium officinale (SSYOF), Stellaria media (STEME), Thlaspi arvense (THLAR), Tripleurospermum inodorum (MATIN), Veronica hederifolia (VERHE), Veronica persica (VERPE) and Viola arvensis (VIOAR), yet more preferably selected from the weed species Aethusa cynapium (AETCY), Aethusa sp. (AETSS), Anthemis arvensis (ANTAR), Apera spica-venti (APESV), Capsella bursa-pastoris (CAPBP), Centaurea cyanus (CENCY), Chenopodium album (CHEAL), Daucus carota (DAUCA), Descurainia sophia (DESSO), Galium aparine (GALAP), Geranium dissectum (GERDI), Geranium pusillium (GERPU), Geranium rotundifolium (GERRT), Lamium amplexicaule (LAMAM), Lamium purpureum (LAMPU), Matricaria chamomilla (MATCH), Papaver rhoeas (PAPRH), Polygonum convolvulus (POLCO), Sysimbrium officinale (SSYOF), Stellaria media (STEME), Tripleurospermum inodorum (MATIN), Veronica hederifolia (VERHE), Veronica persica (VERPE) and Viola arvensis (VIOAR), still more preferably selected from the weed species Aethusa cynapium (AETCY), Aethusa sp. (AETSS), Anthemis arvensis (ANTAR), Apera spica-venti (APESV), Capsella bursa-pastoris (CAPBP), Centaurea cyanus (CENCY), Chenopodium album (CHEAL), Daucus carota (DAUCA), Descurainia sophia (DESSO), Galium aparine (GALAP), Geranium dissectum (GERDI), Geranium pusillium (GERPU), Geranium rotundifolium (GERRT), Lamium purpureum (LAMPU), Matricaria chamomilla (MATCH), Papaver rhoeas (PAPRH), Stellaria media (STEME), Tripleurospermum inodorum (MATIN), Veronica hederifolia (VERHE), Veronica persica (VERPE) and Viola arvensis (VIOAR), especially preferably selected from the weed species Anthemis arvensis (ANTAR), Capsella bursa-pastoris (CAPBP), Chenopodium album (CHEAL), Daucus carota (DAUCA), Geranium rotundifolium (GERRT), Lamium purpureum (LAMPU), Papaver rhoeas (PAPRH), Veronica hederifolia (VERHE), Veronica persica (VERPE) and Viola arvensis (VIOAR), and most preferably selected from the weed species Anthemis arvensis (ANTAR), Geranium rotundifolium (GERRT), Papaver rhoeas (PAPRH), Veronica hederifolia (VERHE) and Viola arvensis (VIOAR).

In another embodiment, the undesirable vegetation is selected from the genera Centaurea, Geranium, Papaver and Tripleurospermum.

In yet another embodiment, the undesirable vegetation is selected from the weed species Centaurea cyanus (CENCY), Geranium dissectum (GERDI), Geranium pusillium (GERPU), Geranium rotundifolium (GERRT), Papaver rhoeas (PAPRH) and Tripleurospermum inodorum (MATIN).

The herbicidal composition according to the invention is suitable as herbicide as such or as an appropriately formulated agrochemical formulation. As used herein, the term “agrochemical formulation” or “formulation” refers to a composition according to the invention further comprising one or more auxiliaries customary in crop protection.

Thus, the invention also relates to a formulation comprising the herbicidal composition and one or more auxiliaries customary in crop protection.

The components of the herbicidal composition, i.e. the herbicide A, herbicide B, built-in adjuvant C, optionally the herbicide D and optionally the safener E, can be converted into customary types of formulations, e. g. solutions, emulsions, suspensions, dusts, powders, pastes, granules, pressings, capsules, and mixtures thereof. Examples for formulation types are suspensions (e.g. SC, OD, FS), emulsifiable concentrates (e.g. EC), emulsions (e.g. EW, EO, ES, ME), capsules (e.g. CS, ZC), pastes, pastilles, wettable powders or dusts (e.g. WP, SP, WS, DP, DS), pressings (e.g. BR, TB, DT), granules (e.g. WG, SG, GR, FG, GG, MG), insecticidal articles (e.g. LN), as well as gel formulations for the treatment of plant propagation materials such as seeds (e.g. GF). These and further formulation types are defined in the “Catalogue of pesticide formulation types and international coding system”, Technical Monograph No. 2, 6^{th} Ed. May 2008, CropLife International.

The formulations can be prepared in a known manner, such as described by Mollet and Grubemann, Formulation technology, Wiley VCH, Weinheim, 2001; or Knowles, New developments in crop protection product formulation, Agrow Reports DS243, T&F Informa, London, 2005.

Thus, the invention also relates to a process for preparing the formulation which comprises mixing herbicide A, herbicide B, built-in adjuvant C, optionally herbicide D and/or safener E and one or more auxiliaries customary in crop protection.

Suitable auxiliaries are solvents, liquid carriers, solid carriers or fillers, surfactants, dispersants, emulsifiers, wetting agents, solubilizers, penetration enhancers, protective colloids, adhesion agents, thickeners, humectants, repellents, attractants, feeding stimulants, compatibilizers, bactericides, anti-freezing agents, anti-foaming agents, colorants, tackifiers and binders.

Suitable solvents and liquid carriers are water and organic solvents, such as mineral oil fractions of medium to high boiling point, e.g. kerosene, diesel oil; oils of vegetable or animal origin; aliphatic, cyclic and aromatic hydrocarbons, e. g. toluene, paraffin, tetrahydronaphthalene, alkylated naphthalenes; alcohols, e.g. ethanol, propanol, butanol, benzylalcohol, cyclohexanol; glycols; DMSO; ketones, e.g. cyclohexanone; esters, e.g. lactates, carbonates, fatty acid esters, gamma-butyrolactone; fatty acids; phosphonates; amines; amides, e.g. N-methylpyrrolidone, fatty acid dimethylamides; and mixtures thereof. Preferred solvents are selected from aromatic hydrocarbons, 2,2,4-trimethyl-1,3-pentanediol monoisobutyrate, N, N-dimethyl(C₂-C₂₀) hydroxyalkylamides, and any combination thereof.

Suitable solid carriers or fillers are mineral earths, e.g. silicates, silica gels, talc, kaolins, limestone, lime, chalk, clays, dolomite, diatomaceous earth, bentonite, calcium sulfate, magnesium sulfate, magnesium oxide; polysaccharides, e.g. cellulose, starch; fertilizers, e.g. ammonium sulfate, ammonium phosphate, ammonium nitrate, ureas; products of vegetable origin, e.g. cereal meal, tree bark meal, wood meal, nutshell meal, and mixtures thereof.

Suitable surfactants are surface-active compounds, such as anionic, cationic, nonionic and amphoteric surfactants, block polymers, polyelectrolytes, and mixtures thereof. Such surfactants can be used as emulsifier, dispersant, solubilizer, wetter, penetration enhancer, or protective colloid. Examples of surfactants are listed in McCutcheon's, Vol. 1: Emulsifiers & Detergents, McCutcheon's Directories, Glen Rock, USA, 2008 (International Ed. or North American Ed.).

Suitable anionic surfactants are alkali, alkaline earth or ammonium salts of sulfonates, sulfates, phosphates, carboxylates, and mixtures thereof. Examples of sulfonates are alkylarylsulfonates, diphenylsulfonates, alpha-olefin sulfonates, lignine sulfonates, sulfonates of fatty acids and oils, sulfonates of ethoxylated alkylphenols, sulfonates of alkoxylated arylphenols, sulfonates of condensed naphthalenes, sulfonates of dodecyl- and tridecylbenzenes, sulfonates of naphthalenes and alkylnaphthalenes, sulfosuccinates or sulfosuccinamates. Examples of sulfates are sulfates of fatty acids and oils, of ethoxylated alkylphenols, of alcohols, of ethoxylated alcohols, or of fatty acid esters. Examples of phosphates are phosphate esters. Examples of carboxylates are alkyl carboxylates, and carboxylated alcohol or alkylphenol ethoxylates. Preferred anionic surfactants are selected from polyarylphenol polyalkoxyether sulfates and/or phosphates, C₈₋₁₈ alcohol polyalkoxyether phosphates, carboxylates, and/or citrates, and any combination thereof

Suitable nonionic surfactants are alkoxylates, N-substituted fatty acid amides, amine oxides, esters, sugar-based surfactants, polymeric surfactants, and mixtures thereof. Examples of alkoxylates are compounds such as alcohols, alkylphenols, amines, amides, arylphenols, fatty acids or fatty acid esters which have been alkoxylated with 1 to 50 equivalents. Ethylene oxide and/or propylene oxide may be employed for the alkoxylation, preferably ethylene oxide. Examples of N-substituted fatty acid amides are fatty acid glucamides or fatty acid alkanolamides. Examples of esters are fatty acid esters, glycerol esters or monoglycerides. Examples of sugar-based surfactants are sorbitans, ethoxylated sorbitans, sucrose and glucose esters or alkylpolyglucosides. Examples of polymeric surfactants are home- or copolymers of vinylpyrrolidone, vinylalcohols, or vinylacetate. Preferred nonionic surfactants are selected from polyalkoxylated alkyl ethers, fatty alcohol polyglycol ethers and any combination thereof.

Suitable cationic surfactants are quaternary surfactants, for example quaternary ammonium compounds with one or two hydrophobic groups, or salts of long-chain primary amines. Suitable amphoteric surfactants are alkylbetains and imidazolines. Suitable block polymers are block polymers of the A-B or A-B-A type comprising blocks of polyethylene oxide and polypropylene oxide, or of the A-B-C type comprising alkanol, polyethylene oxide and polypropylene oxide. Suitable polyelectrolytes are polyacids or polybases. Examples of polyacids are alkali salts of polyacrylic acid or polyacid comb polymers. Examples of polybases are polyvinylamines or polyethyleneamines.

Suitable thickeners are polysaccharides (e.g. xanthan gum, carboxymethylcellulose), inorganic clays (organically modified or unmodified), polycarboxylates, and silicates.

Suitable bactericides are bronopol and isothiazolinone derivatives such as alkylisothiazolinones and benzisothiazolinones.

Suitable anti-freezing agents are ethylene glycol, propylene glycol, urea and glycerin.

Suitable anti-foaming agents are silicones, long chain alcohols, and salts of fatty acids.

Suitable colorants (e.g. in red, blue, or green) are pigments of low water solubility and water-soluble dyes. Examples are inorganic colorants (e.g. iron oxide, titan oxide, iron hexacyanoferrate) and organic colorants (e.g. alizarin-, azo- and phthalocyanine colorants).

Suitable tackifiers, binders or stabilizers are polyvinylpyrrolidons, polyvinylacetates, vinylpyrrolidone-vinyl acetate copolymers, polyvinyl alcohols, polyacrylates, biological or synthetic waxes, microcrystalline cellulose and cellulose ethers.

In a preferred embodiment, the herbicidal composition of this invention is formulated as an oil-in-water emulsion (EW) formulation. In another embodiment, the herbicidal composition of this invention is an oil-in-water emulsion (EW) formulation. Such an oil-in-water emulsion (EW) formulation can be prepared by
a) mixing water, aminopyralid in its acid form and a base (e.g., an alkali metal hydroxide such as potassium hydroxide) to form an aqueous solution of the agriculturally acceptable salt of aminopyralid, preferably aminopyralid-potassium (herbicide B),
b) adding a stabilizer and optionally further hydrophilic auxiliaries to the aqueous solution obtained in step a) to form an aqueous phase,
c) preparing an oil phase comprising the herbicide A (in particular dimethenamid-P), one or more water-insoluble solvents, surfactants selected from nonionic and anionic surfactants and optionally further lipophilic auxiliaries,
d) mixing the oil phase obtained in step c) with the aqueous phase obtained in step b) under stirring and subsequent high shear homogenization to obtain an oil-in-water emulsion, and
e) adding the built-in adjuvant C to the oil-in-water emulsion obtained in step d) under stirring and subsequent high shear homogenization to obtain the oil-in-water emulsion formulation.

In the aforementioned process, the order of addition of the various ingredients used in both the oil and aqueous phase is of minor importance. This also applies to the order of combining the oil phase with the aqueous phase. Some of the optional auxiliaries may even be added after the mixing of the oil and aqueous phase. The above mixing and/or homogenization steps can be accomplished by supplying energy into the mixture of the phases by means of shaking, beating, stirring, turbulent mixing (for example rotor-stator mixer); by injecting one fluid into another; by oscillations and cavitation in the mixture (for example ultrasound); by means of emulsifying centrifuges; by means of colloid mills and homogenizers; or by means of a jet nozzle. Further, heat and/or agitation may be applied to ease the formation of a homogeneous phase.

The herbicidal composition or formulation according to the invention may comprise the herbicide A (in particular dimethenamid-P) in a concentration of at least 20% by weight, preferably at least 30% by weight, more preferably at least 40% by weight, in each case based on the total weight of the composition or formulation. The herbicidal composition or formulation of this invention may comprise the herbicide A (in particular dimethenamid-P) in a concentration of up to 70% by weight, preferably up to 60% by weight, more preferably up to 50% by weight, in each case based on the total weight of the composition or formulation. The herbicidal composition or formulation of this invention may comprise the herbicide A (in particular dimethenamid-P) in a concentration of from 10 to 70% by weight, preferably 20 to 60% by weight, more preferably 30 to 60% by weight, most preferably 40 to 50% by weight, in each case based on the total weight of the composition or formulation.

The herbicidal composition or formulation according to the invention may comprise the herbicide B (in particular aminopyralid-potassium) in a concentration of at least 0.005% by weight, preferably at least 0.01% by weight, more preferably at least 0.05% by weight, most preferably at least 0.1% by weight, in particular at least 0.5% by weight, in each case based on the total weight of the composition or formulation. The herbicidal composition or formulation of this invention may comprise the herbicide B (in particular aminopyralid-potassium) in a concentration of up to 10% by weight, preferably up to 5% by weight, more preferably up to 1% by weight, in each case based on the total weight of the composition or formulation. The herbicidal composition or formulation of this invention may comprise the herbicide B (in particular aminopyralid-potassium) in a concentration of from 0.01 to 10% by weight, preferably 0.05 to 5% by weight, more preferably 0.1 to 2.5% by weight, most preferably 0.5 to 1% by weight, in each case based on the total weight of the composition or formulation.

The herbicidal composition or formulation according to the invention typically comprises the built-in adjuvant C (preferably selected from polyoxyethylene sorbitan fatty acid esters, more preferably polyoxyethylene sorbitan monolaurate and in particular polyoxyethylene (20) sorbitan monolaurate) in a concentration of at least 0.1% by weight, preferably at least 0.5% by weight, more preferably at least 1% by weight, most preferably at least 2% by weight, in each case based on the total weight of the composition or formulation. The herbicidal composition or formulation of this invention may comprise the built-in adjuvant C (preferably selected from polyoxyethylene sorbitan fatty acid esters, more preferably polyoxyethylene sorbitan monolaurate and in particular polyoxyethylene (20) sorbitan monolaurate) in a concentration of up to 20% by weight, preferably up to 15% by weight, more preferably up to 10% by weight, most preferably up to 8% by weight, in each case based on the total weight of the composition or formulation. The herbicidal composition or formulation of this invention typically comprises the built-in adjuvant C (preferably selected from polyoxyethylene sorbitan fatty acid esters, more preferably polyoxyethylene sorbitan monolaurate and in particular polyoxyethylene (20) sorbitan monolaurate) in a concentration of from 0.1 to 20% by weight, preferably 0.5 to 15% by weight, more preferably 1 to 10% by weight, most preferably 2 to 8% by weight, in each case based on the total weight of the composition or formulation.

In a preferred embodiment, the herbicidal composition or formulation of this invention comprises
a) 30 to 60 wt. % of a herbicide A selected from dimethenamid, dimethenamid-P and any mixture thereof,
b) 0.1 to 2.5 wt. % of a herbicide B which is an agriculturally acceptable salt of aminopyralid, and
c) 1 to 10 wt. % of a built-in adjuvant C selected from polyoxyalkylene sorbitan fatty acid esters,
wherein the amounts given in wt. % are each based on the total weight of the composition or formulation.

In another preferred embodiment, the herbicidal composition or formulation of this invention comprises
a) 30 to 60 wt. % of a herbicide A which is dimethenamid-P,
b) 0.1 to 2.5 wt. % of a herbicide B which is selected from aminopyralid-potassium, aminopyralid-dimethylammonium, aminopyralid-triisopropanolamine salt, and any combination thereof, and
c) 1 to 10 wt. % of a built-in adjuvant C selected from polyoxyethylene sorbitan fatty acid esters,
wherein the amounts given in wt. % are each based on the total weight of the composition or formulation.

In another preferred embodiment, the herbicidal composition or formulation of this invention comprises
a) 30 to 60 wt. % of a herbicide A which is dimethenamid-P,
b) 0.1 to 2.5 wt. % of a herbicide B which is aminopyralid-potassium, and
c) 1 to 10 wt. % of a built-in adjuvant C which is polyoxyethylene sorbitan monolaurate, preferably polyoxyethylene (20) sorbitan monolaurate,
wherein the amounts given in wt. % are each based on the total weight of the composition or formulation.

In another preferred embodiment, the herbicidal composition or formulation of this invention comprises
a) 40 to 50 wt. % of a herbicide A selected from dimethenamid, dimethenamid-P and any mixture thereof,
b) 0.5 to 1 wt. % of a herbicide B which is an agriculturally acceptable salt of aminopyralid, and
c) 2 to 8 wt. % of a built-in adjuvant C selected from polyoxyalkylene sorbitan fatty acid esters,
wherein the amounts given in wt. % are each based on the total weight of the composition or formulation.

In another preferred embodiment, the herbicidal composition or formulation of this invention comprises
a) 40 to 50 wt. % of a herbicide A which is dimethenamid-P,
b) 0.5 to 1 wt. % of a herbicide B which is selected from aminopyralid-potassium, aminopyralid-dimethylammonium, aminopyralid-triisopropanolamine salt, and any combination thereof, and
c) 2 to 8 wt. % of a built-in adjuvant C selected from polyoxyethylene sorbitan fatty acid esters,
wherein the amounts given in wt. % are each based on the total weight of the composition or formulation.

In another preferred embodiment, the herbicidal composition or formulation of this invention comprises
a) 40 to 50 wt. % of a herbicide A which is dimethenamid-P,
b) 0.5 to 1 wt. % of a herbicide B which is aminopyralid-potassium, and
c) 2 to 8 wt. % of a built-in adjuvant C which is polyoxyethylene sorbitan monolaurate, preferably polyoxyethylene (20) sorbitan monolaurate,
wherein the amounts given in wt. % are each based on the total weight of the composition or formulation.

Another aspect of the present invention is the use of the herbicidal composition or formulation according to the invention in agrochemical applications (e.g. crop protection, agricultural non-crop applications, seed treatment), pharmaceutical applications, personal care applications (e.g. cosmetic applications), textile applications, human or animal nutrition applications, chemical process applications, adhesives and sealants, paints and coatings, building and construction materials, self-healing materials, tobacco industry, household applications.

In one embodiment, the herbicidal composition or formulation according to the invention is used in crop protection.

The herbicidal composition, formulation, use and method of the present invention are particularly important in the control of a multitude of undesirable vegetation on various cultivated plants, such as cereals, e.g. wheat, rye, barley, triticale, oats or rice; beet, e. g. sugar beet or fodder beet; fruits, such as pomes, stone fruits or soft fruits, e. g. apples, pears, plums, peaches, almonds, cherries, strawberries, raspberries, blackberries or gooseberries; leguminous plants, such as lentils, peas, alfalfa or soybeans; oil plants, such as rape, mustard, olives, sunflowers, coconut, cocoa beans, castor oil plants, oil palms, ground nuts or soybeans; cucurbits, such as squashes, cucumber or melons; fiber plants, such as cotton, flax, hemp or jute; citrus fruit, such as oranges, lemons, grapefruits or mandarins; vegetables, such as spinach, lettuce, asparagus, cabbages, carrots, onions, tomatoes, potatoes, cucurbits or paprika; lauraceous plants, such as avocados, cinnamon or camphor; energy and raw material plants, such as corn, soybean, rape, sugar cane or oil palm; corn; tobacco; nuts; coffee; tea; bananas; vines (Table grapes and grape juice grape vines); hop; turf; sweet leaf (also called Stevia); natural rubber plants or ornamental and forestry plants, such as flowers, shrubs, broad-leaved trees or evergreens, e. g. conifers; and on the plant propagation material, such as seeds, and the crop material of these plants.

Preferred crops are Arachis hypogaea, Beta vulgaris spec. altissima, Brassica napus var. napus, Brassica oleracea, Citrus limon, Citrus sinensis, Coffea arabica (Coffea canephora, Coffea liberica), Cynodon dactylon, Glycine max, Gossypium hirsutum, (Gossypium arboreum, Gossypium herbaceum, Gossypium vitifolium), Helianthus annuus, Hordeum vulgare, Juglans regia, Lens culinaris, Linum usitatissimum, Lycopersicon lycopersicum, Malus spec., Medicago sativa, Nicotiana tabacum (N. rustica), Olea europaea, Oryza sativa, Phaseolus lunatus, Phaseolus vulgaris, Pistacia vera, Pisum sativum, Prunus dulcis, Saccharum officinarum, Secale cereale, Solanum tuberosum, Sorghum bicolor (s. vulgare), Triticale, Triticum aestivum, Triticum durum, Vicia faba, Vitis vinifera and Zea mays.

More preferably, the crop plants are selected from cereals, corn, soybeans, rice, Brassica crops, cotton, potatoes, peanuts or permanent crops.

Especially preferred crops are crops of cereals, corn, soybeans, rice, oilseed rape, canola, cotton, potatoes, peanuts or permanent crops.

In a particularly preferred embodiment, the undesirable vegetation is controlled in Brassica crops, yet more preferably oilseed rape or canola, in particular oilseed rape and most preferably winter oilseed rape. In another particularly preferred embodiment, the crop is selected from the genus Brassica, yet more preferably from oilseed rape or canola. In particular, the crop is oilseed rape, most preferably winter oilseed rape.

According to the invention, all the crop plants (cultivated plants) mentioned herein are understood to comprise all species, subspecies, variants and/or hybrids which belong to the respective cultivated plants, including but not limited to winter and spring varieties, in particular in cereals such as wheat and barley, as well as oilseed rape, e.g. winter wheat, spring wheat, winter barley, winter oilseed rape and spring oilseed rape.

The term “Brassica crops” as used herein includes, but is not limited to, all varieties of canola and oilseed rape (Brassica napus, BRSNN), forage brassica, garden brassica and seed producing brassica, including spring rape or Spring Argentine canola (Brassica napus, BRSNS), winter oilseed rape (Brassica napus, BRSNW), Roundup Ready® canola (Brassica napus, RRBRSNN), Nexera™ canola (Brassica napus, BRSNN-NEX), stem kale (Brassica oleracea var. acephala subvar. medullosa, BRSOM), Aparima Gold swede (Brassica sp., BRSSS), rutabaga (Brassica napus var. napobrassica, BRSNA), turnip or Polish canola (Brassica rapa, BRSRR), kale/Chinese kale (Brassica alboglabra, BRSAG), Juncea canola or brown mustard (Brassica juncea, BRSJU), broccoli/cauliflower (Brassica oleracea [botrytis], BRSOK), cabbage (Brassica oleracea [capitata], BRSOL), Abyssinian mustard (Brassica carinata, BRSCA), yellow mustard (Sinapis alba, SINAL) and Gold-of-Pleasure (Camelina sativa, CMASA).

The term “crop plants” also includes those plants which have been modified by breeding, mutagenesis or methods, including the biotechnological agricultural products which are on the market or in the process of being developed. Genetically modified plants are plants whose genetic material has been modified in a manner which does not occur under natural conditions by hybridizing, mutations or natural recombination (i.e. recombination of the genetic material). Here, one or more genes will, as a rule, be integrated into the genetic material of the plant in order to improve the properties of the plants. Such recombinant modifications also comprise posttranslational modifications of proteins, oligo- or polypeptides, for example by means of glycosylation or binding polymers such as, for example, prenylated, acetylated or farnesylated residues or PEG residues.

When used in crop protection, the herbicidal composition or formulation according to the invention may be applied as such or is preferably applied after dilution with water. Preferably, for various purposes of end user application, a so-called aqueous spray-liquor is prepared by diluting the herbicidal composition or formulation of the present invention with water. The spray-liquors may also comprise further constituents in dissolved, emulsified or suspended form, for example fertilizers, active substances of other groups of herbicidal or growth-regulatory active substances, further active substances, for example active substances for controlling animal pests or phytopathogenic fungi or bacteria, furthermore mineral salts which are employed for alleviating nutritional and trace element deficiencies, and non-phytotoxic oils or oil concentrates. These agents can be admixed with the herbicidal composition or formulation according to the invention in a weight ratio of 1:100 to 100:1, preferably 1:10 to 10:1. As a rule, these constituents are added to the spray mixture before, during or after dilution of the herbicidal composition according to the invention. The herbicidal composition or formulation of this invention is usually applied from a pre-dosage device, a knapsack sprayer, a spray tank, a spray plane, or an irrigation system. Usually, 20 to 2000 liters, preferably 50 to 400 liters, of the ready-to-use spray liquor are applied per hectare of agricultural useful area.

In the method and use of the invention, the herbicidal composition or formulation according to the invention can be applied pre-emergence (i.e., before the emergence of undesirable vegetation) or post-emergence (i.e., during and/or after emergence of the undesirable vegetation).

Preferably, the herbicidal composition or formulation according to the invention is applied before the emergence of the undesirable vegetation (pre-emergence).

More preferably, the herbicidal composition or formulation according to the invention is applied before or after the emergence of the undesirable vegetation (pre-emergence or post-emergence).

In another embodiment, the herbicidal composition or formulation according to the invention is applied after the emergence of the undesirable vegetation (post-emergence).

In case of post-emergence treatment, the herbicidal composition or formulation according to the invention is preferably applied after the undesirable vegetation has emerged and has developed up to 6 leaves.

If one of the active compounds is less well tolerated by certain crop plants, application techniques may be employed where the herbicidal composition of this invention is sprayed, with the aid of the spraying apparatus, in such a way that the leaves of the sensitive crop plants ideally do not come into contact with them, while the active substances reach the leaves of undesired plants which grow underneath, or the bare soil surface (post-directed, lay-by).

Various types of oils, wetting agents, adjuvants, fertilizer, or micronutrients, and further pesticides (e.g., herbicides, insecticides, fungicides, growth regulators, safeners) may be added to the compositions comprising them as premix or, if appropriate not until immediately prior to use (tank mix). These agents can be admixed with the herbicidal composition or formulation according to the invention in a weight ratio of 1:100 to 100:1, preferably 1:10 to 10:1.

The herbicidal composition or formulation of the invention is generally applied in such amounts that the amounts of the herbicides A and B applied are, depending on the kind of effect desired, from 0.01 to 10 kg per ha (hectare), preferably from 0.05 to 5 kg per ha, more preferably from 0.1 to 3.5 kg per ha, in particular from 0.1 to 2.5 kg per ha.

In the method and use of the invention, the application rate of the herbicide A (in particular dimethenamid-P) is generally from 0.1 to 2000 g/ha, preferably 10 to 1500 g/ha, more preferably 100 to 1000 g/ha, yet more preferably and in particular 200 to 800 g/ha.

In the method and use of the invention, the application rate of the herbicide B (in particular aminopyralid-potassium), calculated on an acid equivalent basis, is generally from 0.1 to 100 g/ha, preferably 1 to 50 g/ha, more preferably 1 to 10 g/ha and in particular 2 to 8 g/ha.

In the method and use of the invention, the application rate of the built-in adjuvant C (preferably polyoxyethylene sorbitan monolaurate, in particular polyoxyethylene (20) sorbitan monolaurate) is generally from 0.1 to 500 g/ha, preferably 1 to 250 g/ha, more preferably 10 to 100 g/ha and in particular 20 to 60 g/ha.

In the method and use of the invention, the application rate of the herbicide D (in case of salts or esters calculated as the acid) is generally from 0.1 to 10000 g/ha.

In the method and use of the invention, the application rate of the safener E (in case of salts or esters calculated as the acid) is generally from 1 to 2500 g/ha, preferably 2 to 2000 g/ha and more preferably 5 to 1500 g/ha.

The examples which follow illustrate the invention without imposing any limitation.

### Example 1

### Composition 1 (Invention)

A herbicidal composition according to the invention (hereinafter referred to as “Composition 1”) was formulated as an oil-in-water emulsion (EW) formulation containing 500 g/l of dimethenamid-P (herbicide A), 6 g/l of aminopyralid-potassium (herbicide B, amount calculated on an acid equivalent basis) and 50 g/l of polyoxyethylene (20) sorbitan monolaurate (built-in adjuvant C, commercially available as Tween® 20).

### Composition 2 (Comparison)

For comparative purposes, a herbicidal composition (hereinafter referred to as “Composition 2”) was formulated as an oil-in-water emulsion (EW) formulation by using the same components and in the same amounts as Composition 1 except that the built-in adjuvant C (polyoxyethylene (20) sorbitan monolaurate) was replaced by water.

The individual components and their amounts (given in g/l) of Composition 1 (invention) and Composition 2 (comparison) are summarized in Table 1 below.

TABLE 1
Components and amounts of Compositions
1 (invention) and 2 (comparison)

| | Compo- | | Compo- | |
|---|---|---|---|---|
| | sition 1 | | sition 2 | |
| | (inven- | | (compar- | |
| Component* | tion) | | ison) | |
| Dimethenamid-P (herbicide A) | 500 | g/l | 500 | g/l |
| Aminopyralid-potassium (herbicide B)** | 6 | g/l | 6 | g/l |
| Polyoxyethylene (20) sorbitan monolaurate, | 50 | g/l | — | |
| commercial product: Tween ®20 | | | | |
| (built-in adjuvant C) | | | | |
| Aromatic hydrocarbon mixture, initial boiling | 50 | g/l | 50 | g/l |
| point at 220° C., final boiling point at 305° C., | | | | |
| maximum naphthalene content of 0.9 wt. % | | | | |
| (solvent 1) | | | | |
| 2,2,4-trimethyl-1,3-pentanediol monoisobutyrate | 50 | g/l | 50 | g/l |
| (solvent 2) | | | | |
| Polyalkylene glycol butyl ether, the polyalkylene | 17.5 | g/l | 17.5 | g/l |
| glycol unit being an ethylene oxide/propylene | | | | |
| oxide block copolymer, OH number 17- | | | | |
| 26 mg KOH/g, HLB value 14, molar weight | | | | |
| 5200 g/mol (surfactant 1) | | | | |
| Ethoxylated isotridecyl alcohol, degree of | 17.5 | g/l | 17.5 | g/l |
| ethoxylation approximately 6 (surfactant 2) | | | | |
| Tristyrylphenol (ethylene oxide)₁₆ sulfate | 10 | g/l | 10 | g/l |
| ammonium salt (surfactant 3) | | | | |
| Poly(vinylpyrrolidone co-vinyl acetate), having | 20 | g/l | 20 | g/l |
| a ratio of vinylpyrrolidone (VP) to vinyl acetate | | | | |
| (VA) in a weight ratio of 60:40 (stabilizer 1) | | | | |
| Microcrystalline cellulose powder with an | 5 | g/l | 5 | g/l |
| average particle size of 20 μm (stabilizer 2) | | | | |
| Glycerin (antifreeze agent) | 125 | g/l | 125 | g/l |
| Anti-foaming agents | 0.5 | g/l | 0.5 | g/l |
| Preservatives | 2 | g/l | 2 | g/l |

| | | |
|---|---|---|
| Water | Ad 1 l | Ad 1 l |

*all components listed in Table 1 are commercially available
**amount of herbicide B calculated on an acid equivalent basis

### Example 2 (Herbicidal Activity and Phytotoxicity Tested in Field Trials)

The herbicidal activity and phytotoxicity on cultivated plants of the Composition 1 (invention) and Composition 2 (comparison) according to Table 1 were tested in the following field trials:

Trials were conducted under field conditions in a randomized bloc design with 3-4 replication in different European regions. Crop cultivation including soil preparation, sowing, fertilization and maintaining plant protection measures were implemented according to local or regional practices.

Composition 1 (invention) and Composition 2 (comparison) were both diluted with 145-300 l/ha water to provide a diluted composition before application.

For the pre-emergence treatment, the diluted composition as described above was applied either directly after sowing or until shortly before emergence of the crop by means of finely distributing nozzles.

For the post-emergence treatment, winter oilseed rape grown to a growth stage up to BBCH 16, depending on the plant habit, and only then treated with the diluted formulation as described above. Growth stages of weeds present at the time of post-emergence application ranged from BBCH 09-16 (emergence till 6 leaf-stage). The test period extended till the onset of the vegetation period in the spring following the application in autumn.

The application rates of each of the Composition 1 (invention) and Composition 2 (comparison) were 0.6 and 1.0 l/ha for both the pre-emergence and the post-emergence treatment.

The response of the crop and the weeds to the individual treatments was evaluated.

Evaluation was carried out using a scale from 0 to 100. 100 means no emergence of the plants, or complete destruction of at least the above-ground parts, and 0 means no damage or normal course of growth. A good herbicidal activity is given at values of at least 70, and very good herbicidal activity is given at values of at least 85. Phytotoxicity means herbicidal activity on cultivated plants.

The tested weeds present in the trial area sown with winter oilseed rape (BRSNW) were of natural occurrence. Efficacy and phytotoxicity were evaluated about 6-32 weeks following the application in autumn.

Test plants in pre-emergence application were Aethusa sp. (AETSS), Anthemis arvensis (ANTAR), Apera spica-venti (APESV), Capsella bursa-pastoris (CAPBP), Centaurea cyanus (CENCY), Chenopodium album (CHEAL), Daucus carota (DAUCA), Descurainia sophia (DESSO), Geranium dissectum (GERDI), Geranium pusillium (GERPU), Lamium purpureum (LAMPU), Matricaria chamomilla (MATCH), Papaver rhoeas (PAPRH), Stellaria media (STEME), Tripleurospermum inodorum (MATIN), Veronica hederifolia (VERHE), Veronica persica (VERPE) and Viola arvensis (VIOAR), on the undesired vegetation side, and on the other side, for phytotoxicity tests, winter oilseed rape (BRSNW).

For the post-emergence application, test plants were Aethusa cynapium (AETCY), Anthemis arvensis (ANTAR), Capsella bursa-pastoris (CAPBP), Daucus carota (DAUCA), Galium aparine (GALAP), Geranium dissectum (GERDI), Geranium rotundifolium (GERRT), Lamium purpureum (LAMPU), Matricaria chamomilla (MATCH), Papaver rhoeas (PAPRH), Veronica hederifolia (VERHE), Veronica persica (VERPE) and Viola arvensis (VIOAR) on the undesired vegetation side, and on the other side, for phytotoxicity tests, winter oilseed rape (BRSNW).

The results are compiled in Tables 2 to 5 below.

TABLE 2
Herbicidal activity and phytotoxicity of Composition 1 (invention)
and Composition 2 (comparison) applied pre-emergence in winter
oilseed rape (BRSNW) at an application rate of 0.6 l/ha

| | | Herbicidal activity/phytotoxicity | | Δ |
|---|---|---|---|---|
| | | Composition 1 | Composition 2 | (Composition |
| Trial | Plant | (invention) | (comparison) | 1 vs. |
| No. | species | 0.6 l/ha | 0.6 l/ha | Composition 2) |
| 1 | BRSNW | 0 | 0 | 0 |
| | CAPBP | 83 | 78 | 5 |
| 2 | BRSNW | 0 | 0 | 0 |
| | VERHE | 85 | 60 | 25 |
| | PAPRH | 98 | 87 | 11 |
| | DESSO | 92 | 87 | 5 |
| 3 | BRSNW | 0 | 0 | 0 |
| | VERHE | 89 | 86 | 3 |
| 4 | BRSNW | 0 | 0 | 0 |
| | LAMPU | 92 | 80 | 12 |
| | ANTAR | 97 | 93 | 4 |
| 5 | BRSNW | 0 | 0 | 0 |
| | CAPBP | 97 | 92 | 5 |
| | MATCH | 93 | 91 | 2 |
| | PAPRH | 95 | 84 | 11 |
| | STEME | 96 | 95 | 1 |
| 6 | BRSNW | 2 | 0 | 2 |
| | MATCH | 92 | 85 | 7 |
| 7 | BRSNW | 0 | 0 | 0 |
| | CHEAL | 94 | 81 | 13 |
| | AETSS | 90 | 88 | 2 |
| 8 | BRSNW | 0 | 0 | 0 |
| | MATIN | 100 | 95 | 5 |
| | CENCY | 100 | 98 | 2 |
| | VIOAR | 87 | 70 | 17 |
| 9 | BRSNW | 0 | 0 | 0 |
| | VIOAR | 88 | 68 | 20 |
| | PAPRH | 96 | 90 | 6 |
| 10 | BRSNW | 0 | 0 | 0 |
| | PAPRH | 88 | 83 | 5 |
| 11 | BRSNW | 0 | 0 | 0 |
| | MATIN | 98 | 91 | 7 |
| 12 | BRSNW | 0 | 0 | 0 |
| | PAPRH | 97 | 94 | 3 |
| | STEME | 92 | 90 | 2 |

TABLE 3
Herbicidal activity and phytotoxicity of Composition 1 (invention)
and Composition 2 (comparison) applied pre-emergence in winter
oilseed rape (BRSNW) at an application rate of 1 l/ha

| | | Herbicidal activity/phytotoxicity | | Δ |
|---|---|---|---|---|
| | | Composition 1 | Composition 2 | (Composition |
| Trial | Plant | (invention) | (comparison) | 1 vs. |
| No. | species | 1 l/ha | 1 l/ha | Composition 2) |
| 1 | BRSNW | 0 | 0 | 0 |
| | GERPU | 85 | 82 | 3 |
| 2 | BRSNW | 0 | 0 | 0 |
| | CAPBP | 77 | 72 | 5 |
| | LAMPU | 82 | 73 | 9 |
| | GERDI | 85 | 80 | 5 |
| | DAUCA | 82 | 72 | 10 |
| 3 | BRSNW | 0 | 0 | 0 |
| | ANTAR | 100 | 95 | 5 |
| | CAPBP | 95 | 93 | 2 |
| | LAMPU | 92 | 88 | 4 |
| | VERHE | 90 | 83 | 7 |
| | GERDI | 87 | 82 | 5 |
| | VERPE | 92 | 87 | 5 |
| 4 | BRSNW | 2 | 2 | 0 |
| | VIOAR | 87 | 82 | 5 |
| 5 | BRSNW | 0 | 0 | 0 |
| | VIOAR | 100 | 92 | 8 |
| 6 | BRSNW | 0 | 0 | 0 |
| | VIOAR | 99 | 90 | 9 |
| | PAPRH | 99 | 96 | 3 |
| 7 | BRSNW | 0 | 0 | 0 |
| | PAPRH | 91 | 87 | 4 |
| | APESV | 95 | 92 | 3 |
| 8 | BRSNW | 0 | 0 | 0 |
| | CENCY | 94 | 90 | 4 |

TABLE 4
Herbicidal activity and phytotoxicity of Composition 1 (invention)
and Composition 2 (comparison) applied post-emergence in winter
oilseed rape (BRSNW) at an application rate of 0.6 l/ha

| | | Herbicidal activity/phytotoxicity | | Δ |
|---|---|---|---|---|
| | | Composition 1 | Composition 2 | (Composition |
| Trial | Plant | (invention) | (comparison) | 1 vs. |
| No. | species | 0.6 l/ha | 0.6 l/ha | Composition 2) |
| 1 | BRSNW | 0 | 0 | 0 |
| | ANTAR | 97 | 73 | 24 |
| 2 | BRSNW | 0 | 0 | 0 |
| | PAPRH | 93 | 72 | 21 |
| 3 | BRSNW | 0 | 0 | 0 |
| | MATCH | 100 | 96 | 4 |

TABLE 5
Herbicidal activity and phytotoxicity of Composition 1 (invention)
and Composition 2 (comparison) applied post-emergence in winter
oilseed rape (BRSNW) at an application rate of 1.0 l/ha

| | | Herbicidal activity/phytotoxicity | | Δ |
|---|---|---|---|---|
| | | Composition 1 | Composition 2 | (Composition |
| Trial | Plant | (invention) | (comparison) | 1 vs. |
| No. | species | 1 l/ha | 1 l/ha | Composition 2) |
| 1 | BRSNW | 0 | 0 | 0 |
| | CAPBP | 88 | 78 | 10 |
| | DAUCA | 77 | 63 | 14 |
| | GERDI | 80 | 78 | 2 |
| 2 | BRSNW | 0 | 0 | 0 |
| | CAPBP | 93 | 83 | 10 |
| | LAMPU | 100 | 90 | 10 |
| | VERHE | 92 | 83 | 9 |
| | ANTAR | 100 | 93 | 7 |
| | VERPE | 100 | 83 | 17 |
| 3 | BRSNW | 0 | 0 | 0 |
| | VIOAR | 82 | 77 | 5 |
| 4 | BRSNW | 2 | 0 | 2 |
| | AETCY | 93 | 92 | 1 |
| 5 | BRSNW | 0 | 0 | 0 |
| | VIOAR | 78 | 63 | 15 |
| | GERRT | 92 | 50 | 42 |
| | PAPRH | 72 | 63 | 9 |
| 6 | BRSNW | 0 | 0 | 0 |
| | GALAP | 100 | 97 | 3 |
| | LAMPU | 92 | 85 | 7 |
| | MATCH | 95 | 88 | 7 |
| | PAPRH | 75 | 70 | 5 |

The results of the field trials depicted in Tables 2 to 5 demonstrate that the herbicidal activity of a composition comprising herbicide A (in particular dimethenamid-P) and herbicide B (in particular aminopyralid-potassium) can be significantly improved by incorporating a specific built-in adjuvant C selected from polyoxyethylene sorbitan fatty acid esters (in particular polyoxyethylene (20) sorbitan monolaurate) into said composition. Further, the herbicidal composition of this invention provides an excellent herbicidal activity on various weeds, whilst not impairing the crop safety compared to a composition of herbicides A and B without a built-in adjuvant C, in particular in crops like oilseed rape. Moreover, the herbicidal composition of this invention can be used for both pre- and post-emergence weed control, especially in oilseed rape, thus allowing a flexible application timing and still complying with the maximum dose rates of said herbicides A and B.

Example 3 (Herbicidal Activity and Phytotoxicity Tested in the Greenhouse for Compositions with Different Built-In Adjuvants C and without Built-In Adjuvant C)

Herbicidal compositions according to the invention were formulated as an oil-in-water emulsion (EW) formulation containing dimethenamid-P (herbicide A), aminopyralid-potassium (herbicide B) and different built-in adjuvants C selected from polyoxyalkylene sorbitan fatty acid esters such as, for example, polyoxyethylene (20) sorbitan monolaurate (polysorbate 20, Tween® 20), polyoxyethylene-(4)-sorbitan monostearate (polysorbate 61, Tween® 61) and polyoxyethylene(20)-sorbitan monooleate (polysorbate 80, Tween® 80), wherein the same amount was used for each individual component. For comparative purposes, a herbicidal composition was formulated as an oil-in-water emulsion (EW) formulation by using the same components and in the same amounts as the above-mentioned compositions except that the built-in adjuvant C was replaced by water.

The herbicidal activity of the different compositions as mentioned above was demonstrated by the following greenhouse experiments:

The culture containers used were plastic flowerpots containing loamy sand with approximately 3.0% of humus as the substrate. The seeds of the test plants were sown separately for each species.

For the pre-emergence treatment, the test candidates which had been suspended or emulsified in water, were applied directly after sowing by means of finely distributing nozzles. The containers were irrigated gently to promote germination and growth and subsequently covered with transparent plastic hoods until the test plants had rooted. This cover caused uniform germination of the test plants, unless this had been impaired by the test candidates.

For the post-emergence treatment, the test plants were first grown to a height of 3 to 15 cm, depending on the plant habit, and only then treated with the test candidates which had been suspended or emulsified in water. For this purpose, the test plants were either sown directly and grown in the same containers, or they were first grown separately as seedlings and transplanted into the test containers a few days prior to treatment.

Depending on the species, the test plants were kept at 10-25° C. or 20-35° C., respectively. The test period extended over 2 to 4 weeks. During this time, the test plants were tended, and their response to the individual treatments was evaluated.

Evaluation was carried out using a scale from 0 to 100. 100 means no emergence of the test plants, or complete destruction of at least the aerial moieties, and 0 means no damage, or normal course of growth. A good herbicidal activity is given at values of at least 70 and a very good herbicidal activity is given at values of at least 85.

The test plants used in the greenhouse experiments were of the following species:

| EPPO code | Scientific name |
|---|---|
| BRSNW | Brassica napus (winter oilseed rape) |
| PAPRH | Papaver rhoeas |
| MATIN | Tripleurospermum inodorum |
| CENCY | Centaurea cyanus |
| GERDI | Geranium dissectum |
| GERPU | Geranium pusillum |
| GERRT | Geranium rotundifolium |

1. An herbicidal composition comprising
a) an herbicide A selected from dimethenamid, dimethenamid-P, and any mixture thereof,
b) an herbicide B which is an agriculturally acceptable salt of aminopyralid, and
c) a built-in adjuvant C selected from polyoxyalkylene sorbitan fatty acid esters.

2. The herbicidal composition according to claim 1 wherein the herbicide A is dimethenamid-P.

3. The herbicidal composition according to claim 1 wherein the herbicide B is selected from the group consisting of aminopyralid-sodium, aminopyralid-potassium, aminopyralid-choline salt, aminopyralid-ammonium, aminopyralid-methylammonium, aminopyralid-dimethylammonium, aminopyra-lid-isopropylammonium, aminopyralid-hydroxy ethylammonium, aminopyralid-di(hydroxyethyl)ammonium, aminopyralid-tri(hydroxyethyl)ammonium, aminopyralid-hydroxypropylammonium, aminopyralid-di(hydroxypropyl)ammonium, aminopyralid-tri(hydroxypropyl)ammonium, aminopyralid-triisopropanolammonium, aminopyralid-diglycolamine salt, aminopyralidolamine salt, aminopyralid-dimethylamine salt, aminopyra-lid-monoethanolamine salt, aminopyralid-triisopropanolamine salt, and any combination thereof.

4. The herbicidal composition according to claim 1 wherein the herbicide B is aminopyralid-potassium.

5. The herbicidal composition according to claim 1 wherein the built-in adjuvant C is selected from polyoxyethylene sorbitan fatty acid esters.

6. The herbicidal composition according to claim 1 wherein the built-in adjuvant C is polyoxyethylene sorbitan monolaurate.

7. The herbicidal composition according to claim 1 wherein a weight ratio of herbicide A to herbicide B, calculated on an acid equivalent basis, to built-in adjuvant C is in a range from 200:1:125 to 40:1:5.

8. The herbicidal composition according to claim 1 wherein a weight ratio of a total amount of the herbicide A and the herbicide B, calculated on an acid equivalent basis, to built-in adjuvant C is in the range from 80:1 to 1:3.

9. The herbicidal composition according to claim 1 comprising
a) 30 to 60 wt. % of an herbicide A which is dimethenamid-P,
b) 0.1 to 2.5 wt. % of an herbicide B which is aminopyralid-potassium, and
c) 1 to 10 wt. % of a built-in adjuvant C which is polyoxyethylene sorbitan monolaurate,
wherein amounts are given in wt. %, each based on a total weight of the composition.

10. (canceled)

11. A method for controlling undesirable vegetation in a crop comprising applying the herbicidal composition as defined in claim 1 to the vegetation or the locus thereof.

12. A method for improving the herbicidal activity of an herbicidal composition comprising
a) an herbicide A selected from dimethenamid, dimethenamid-P, and any mixture thereof, and
b) an herbicide B which is an agriculturally acceptable salt of aminopyralid, against undesirable vegetation in a crop
comprising incorporating into said composition
c) a built-in adjuvant C selected from polyoxyalkylene sorbitan fatty acid esters.

13. The method according to claim 11 wherein the crop is selected from the genus Brassica.

14. The method according to claim 11 wherein the crop is selected from oilseed rape and canola.

15. The method according to claim 11 wherein the crop is winter oilseed rape.

16. The method according to claim 11 wherein the herbicidal composition is applied pre-emergence before or post-emergence after the emergence of the undesirable vegetation.

17. The method according to claim 11 wherein the undesirable vegetation is selected from the group consisting of genera Aethusa, Anthemis, Apera, Capsella, Centaurea, Chenopodium, Daucus, Descurainia, Galium, Geranium, Lamium, Matricaria, Papaver, Stellaria, Tripleurospermum, Veronica, and Viola.

18. The method according to claim 11 wherein the undesirable vegetation is selected from the group consisting of weed species Aethusa cynapium (AETCY), Aethusa sp. (AETSS), Anthemis arvensis (ANTAR), Apera spica-venti (APESV), Capsella bursa-pastoris (CAPBP), Centaurea cyanus (CENCY), Chenopodium album (CHEAL), Daucus carota (DAUCA), Descurainia sophia (DESSO), Galium aparine (GALAP), Geranium dissectum (GERDI), Geranium pusillium (GERPU), Geranium rotundifolium (GERRT), Lamium purpureum (LAMPU), Matricaria chamomilla (MATCH), Papaver rhoeas (PAPRH), Stellaria media (STEME), Tripleurospermum inodorum (MATIN), Veronica hederifolia (VERHE), Veronica persica (VERPE), and Viola arvensis (VIOAR).

19. The herbicidal composition according to claim 6 wherein the polyoxyethylene sorbitan monolaurate is polyoxyethylene (20) sorbitan monolaurate.

20. The herbicidal composition according to claim 8 wherein the herbicidal A is dimethenamid-P and the herbicide B is aminopyralid-potassium.
